(19) United States
(12) Patent Application Publication
(10) Pub. No.: US 2025/0260594 A1
(43) Pub. Date: Aug. 14, 2025

(54) INFORMATION PROCESSING DEVICE

(71) Applicant: TOYOTA JIDOSHA KABUSHIKI KAISHA, Toyota-shi (JP)

(72) Inventor: Koki MORI, Inuyama-shi (JP)

(73) Assignee: TOYOTA JIDOSHA KABUSHIKI KAISHA, Toyota-shi (JP)

(21) Appl. No.: 18/958,416

(22) Filed: Nov. 25, 2024

(30) Foreign Application Priority Data
Feb. 8, 2024 (JP) 2024-017715

(51) Int. Cl. H04L 12/40

(52) U.S. Cl. CPC H04L 12/40039; H04L 2012/40273

(57) ABSTRACT

The control unit of the information processing device acquires a timing condition designated by the user of the vehicle. The timing condition may be a condition for immediately stopping the communication function of the vehicle related to the remote operation, a condition for specifying a period in which the communication function of the vehicle related to the remote operation is temporarily stopped, or a condition for specifying a day of the week and/or a time zone in which the communication function of the vehicle related to the remote operation is periodically stopped. The control unit of the information processing device sets the communication function to the stop state and/or the standby state according to the acquired timing condition.

### CROSS-REFERENCE TO RELATED APPLICATION

This application claims priority to Japanese Patent Application No. 2024-017715 filed on Feb. 8, 2024, incorporated herein by reference in its entirety.

### BACKGROUND

### 1. Technical Field

The present disclosure relates to an information processing device.

### 2. Description of Related Art

Technology for remotely operating an air conditioner installed in a vehicle is known (e.g., see Japanese Unexamined Patent Application Publication No. 2012-188062 (JP 2012-188062 A)).

### SUMMARY

An object of the present disclosure is to provide technology that can improve convenience for a user when remotely operating a vehicle.

One aspect of the present disclosure is an information processing device. In this case, for example, the information processing device may include a control unit that executes acquiring of a condition that is specified by a user of a vehicle, and that is a time-related condition that is a condition for specifying a period for a communication function of the vehicle relating to remote operations to be placed in at least one of a stopped state and a standby state, and placing the communication function in at least one of the stopped state and the standby state in accordance with the time-related condition that is acquired.

Further, another aspect of the present disclosure may be an information processing method in which a computer executes processing of the information processing device described above, a program for causing the computer to execute the information processing method, or a non-transitory storage medium in which the program is stored in a form readable by the computer.

According to the present disclosure, technology can be provided that can improve convenience for a user when remotely operating a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a system according to an embodiment;

FIG. 2 is a diagram schematically illustrating an example of a screen for setting a timing condition in the embodiment;

FIG. 3A is a diagram schematically illustrating an exemplary temporal conditional datum in an embodiment;

FIG. 3B is a diagram schematically illustrating an exemplary temporal conditional datum in an embodiment;

FIG. 3C is a diagram schematically illustrating an exemplary temporal conditional datum in an embodiment;

FIG. 4 is a flowchart illustrating an example of a first processing routine executed by the communication terminal according to the embodiment;

FIG. 5 is a flow chart illustrating an exemplary second process routine executed by the communication terminal according to the embodiment; and

FIG. 6 is a flowchart illustrating an example of a third processing routine executed by the communication terminal according to the modification.

### DETAILED DESCRIPTION OF EMBODIMENTS

In recent years, a service (hereinafter, also referred to as “remote service”) in which a user remotely operates an in-vehicle device such as an air conditioner and a door lock actuator of a parked vehicle through a terminal such as a smartphone has become widespread. The vehicle subject to the remote service has a communication function for transmitting and receiving a signal related to the remote operation. When the standby state of the communication function (a state in which a signal related to a remote operation can be received) is continued when the vehicle is in an operation stop state (an ignition switch or a power switch is in an off state), there is a possibility that the remaining amount of the battery mounted in the vehicle becomes too small or deterioration of the battery is promoted.

On the other hand, when a certain period (for example, about several days) has elapsed from the stop of the operation of the vehicle (timing at which the ignition switch or the power switch is switched from on to off), a measure is conceivable in which the communication function of the vehicle is automatically switched from the standby state to the stop state (a state in which a signal related to a remote operation cannot be received). However, even when the user does not use the vehicle (when the remote service is not used) during the predetermined period, the communication function of the vehicle stands by in the standby state, and the battery may be unnecessarily consumed. In addition, a user who desires to use a remote service after the predetermined period of time has elapsed is also assumed. Therefore, there is a need for a technique for improving convenience of a user while suppressing unnecessary consumption of a battery.

Therefore, in the information processing device according to the present disclosure, the control unit acquires a timing condition which is a condition designated by the user of the vehicle and is a condition for designating a time when the communication function of the vehicle related to the remote operation is set to the stop state and/or the standby state. Here, the timing condition in the present disclosure may be a condition for immediately stopping the communication function, a condition for specifying a period during which the communication function is temporarily stopped, or a condition for specifying a day of the week and/or a time zone during which the communication function is periodically stopped.

The control unit of the information processing device according to the present disclosure sets the communication function of the vehicle related to the remote operation to the stop state and/or the standby state according to the acquired timing condition. Here, in a case where the timing condition is a condition to immediately bring the communication function of the vehicle related to the remote operation to the stop state, the control unit may immediately bring the communication function of the vehicle related to the remote operation to the stop state in response to the acquisition of the timing condition.

In addition, the timing condition may be a condition for designating a period in which the communication function of the vehicle related to the remote operation is temporarily stopped. In this case, the control unit may stop the communication function of the vehicle related to the remote operation in response to the start time of the period arrives, and the control unit may set the communication function of the vehicle related to the remote operation in the standby state in response to the end time of the period arrives. In a case where a vehicle whose communication function related to the remote operation is automatically stopped in response to a lapse of a certain period from the stop of the operation of the vehicle is targeted, the choice of the start time of the period may be limited. In an example, the choice of the start time of the period may be limited to a time before a certain period elapses from the last deactivation of the vehicle. In some cases, a vehicle in which a communication function related to a remote operation is automatically stopped in response to a lapse of a certain period of time from the stop of the operation of the vehicle is targeted. Thus, in this case, it is possible to suppress the communication function of the vehicle related to the remote operation from being automatically stopped before the start time of the period designated by the user arrives.

In addition, the periodic condition may be a condition for designating a day of the week and/or a time zone for periodically stopping the communication function of the vehicle related to the remote operation. In this case, the control unit may stop the communication function every time the day of the week and/or the time period arrives, and the control unit may set the communication function to the standby state every time the day of the week and/or the time period ends. Here, the periodic condition may be a condition for specifying a day of the week on which the communication function of the vehicle related to the remote operation is periodically stopped. In this case, the control unit may repeatedly execute that the communication function of the vehicle related to the remote operation is stopped in response to the arrival of the designated day of the week, and that the communication function of the vehicle related to the remote operation is set to the standby state in response to the end of the designated day of the week. In addition, the timing condition may be a condition for designating a time period in which the communication function of the vehicle related to the remote operation is periodically stopped. In this case, the control unit may repeatedly execute that the communication function of the vehicle related to the remote operation is stopped in response to the arrival of the designated time period, and that the communication function of the vehicle related to the remote operation is set to the standby state in response to the end of the designated time period. Further, the timing condition may be a condition for specifying a day of the week and a time period in which the communication function of the vehicle related to the remote operation is periodically stopped. In this case, the control unit may repeatedly execute the communication function of the vehicle related to the remote operation to the standby state in response to the arrival of the designated time zone on the designated day of the week and the communication function of the vehicle related to the remote operation to the standby state in response to the end of the designated time zone on the designated day of the week.

According to the information processing device of the present disclosure, it is possible to set the communication function of the vehicle related to the remote operation to the stopped state at a time designated by the user. Accordingly, by specifying a time when the user does not use the vehicle, it is possible to suppress the communication function from keeping waiting in the standby state at the time. As a result, it is possible to improve convenience of the user while suppressing unnecessary consumption of battery power.

In addition, the control unit of the information processing device according to the present disclosure may further execute determining a candidate of a timing condition according to a result of a time when the user has used the vehicle in the past. The control unit of the information processing device according to the present disclosure may further execute outputting information for causing the user to select whether to agree with the candidate. The control unit of the information processing device according to the present disclosure may further execute setting the candidate to the timing condition in response to the user's consent to the candidate. As a result, it is possible to reduce the time and effort for the user to set the timing condition. As a result, the convenience of the user can be further improved.

The information processing device according to the present disclosure is a computer that executes processing related to remote operation of a vehicle. In an example, the information processing device according to the present disclosure may be a computer (for example, a car navigation system, a head unit, or the like) mounted on a vehicle.

### Embodiment

Hereinafter, embodiments of the present disclosure will be described with reference to the drawings. The configurations of the following embodiments are merely examples, and the embodiments described below are merely examples of the present disclosure in all respects. Various modifications or variations may be made without departing from the scope of the present disclosure. In the implementation of the present disclosure, a specific configuration according to the embodiment may be adopted as appropriate. Although the data appearing in the present embodiment is described in a natural language, more specifically, the data is designated by a pseudo language, a command, a parameter, a machine language, or the like that can be recognized by a computer.

### System Configuration

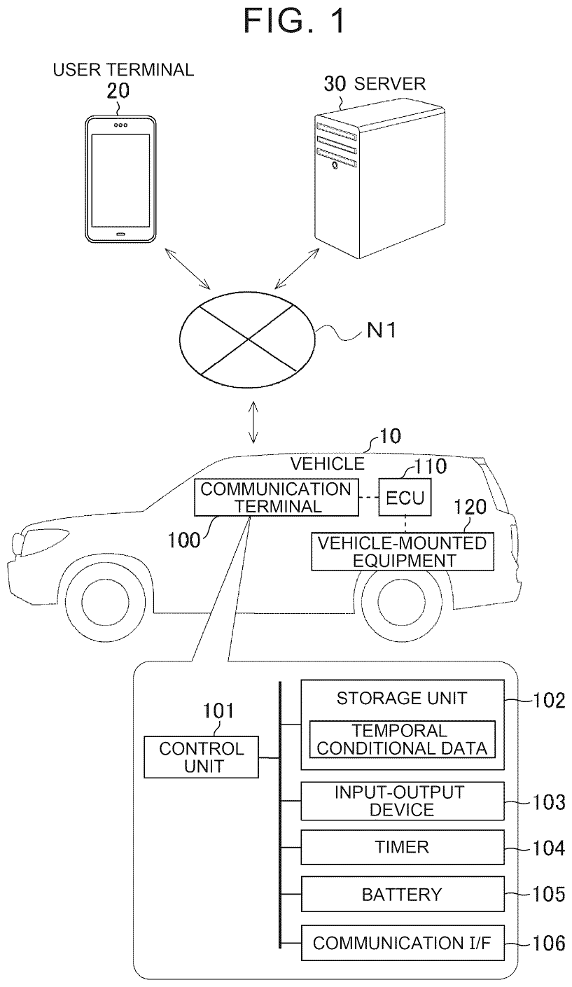

FIG. 1 is a diagram schematically illustrating an example of a configuration of a system to which the present disclosure is applied. The system according to the present embodiment includes a vehicle 10, a user terminal 20, and a server 30, and provides a remote service to a user of the vehicle 10. The remote service is a service in which a user remotely operates the vehicle 10 through the user terminal 20.

The vehicle 10, the user terminal 20, and the server 30 are connected via a network N1. The network N1 is a wide area network (WAN) that is a global public communication network such as the Internet, or any other communication networks. In addition, the network N1 may include a telephone communication network such as a mobile phone network and a wireless communication network such as Wi-Fi (registered trademark). Although only one vehicle 10 and one user terminal 20 are illustrated in FIG. 1, a plurality of vehicles 10 and a plurality of user terminals 20 managed by the server 30 may be included in the system.

The vehicle 10 has a function of operating an in-vehicle device 120, which will be described later, in accordance with a remote command signal transmitted from the server 30. In addition, the vehicle 10 according to the present embodiment has a function of switching between a standby state (a state in which a remote command signal transmitted from the server 30 can be received) and a stop state (a state in which a remote command signal transmitted from the server 30 cannot be received) of the communication terminal 100, which will be described later, according to a timing condition designated by the user.

The user terminal 20 is a computer used by a user of the vehicle 10. The user terminal 20 has a function of receiving a remote operation performed by a user, and a function of transmitting a remote operation signal including information related to the received remote operation (for example, an operation method of an in-vehicle device that is a target of remote operation, and the like) to the server 30. Such a user terminal 20 may, in one example, be a terminal carried by a user (e.g., a smartphone, a tablet terminal, or the like).

The server 30 is one or more computers that perform processing related to remote operation of the vehicle 10. The server 30 has a function of transmitting, to the vehicle 10, a remote command signal for operating a target in-vehicle device by an operation method included in the remote operation signal in response to receiving the remote operation signal transmitted from the user terminal 20.

### Configuration of Vehicle

The vehicle 10 according to the present embodiment includes a communication terminal 100, an ECU 110, and an in-vehicle device 120. The communication terminal 100, ECU 110, and the in-vehicle device 120 are connected to each other through an in-vehicle network based on a standard such as CAN (Controller Area Network), LIN (Local Interconnect Network), or FlexRay.

The communication terminal 100 of the vehicle 10 can be configured as a computer including a processor (such as a CPU or a GPU), a main storage device (such as a RAM and a ROM), and an auxiliary storage device (such as an EPROM, a hard disk drive, and a removable medium). The communication terminal 100 may be configured by combining DCM (Data Communication Module), a head unit, a navigation system, and the like. In the present embodiment, the communication terminal 100 corresponds to an information processing device according to the present disclosure. As illustrated in FIG. 1, such a communication terminal 100 includes a control unit 101, a storage unit 102, an input/output device 103, a timer 104, a battery 105, and a communication I/F 106.

The control unit 101 implements various functions of the communication terminal 100 by executing a dedicated program stored in the storage unit 102. The control unit 101 can be realized by a hardware processor such as a CPU or a DSP, for example. In addition, the control unit 101 may be configured to include a RAM, ROM (Read Only Memory), a cache memory, and the like. Details of the functions realized by the control unit 101 will be described later.

The storage unit 102 includes an auxiliary storage device and stores various types of information. Note that the storage unit 102 may be a storage area constructed in the auxiliary storage device. In addition to OS, the information stored in the storage unit 102 includes a program related to remote control, data used by the program, and the like. The data stored in the storage unit 102 includes temporal condition data relating to a condition (temporal condition) relating to a time when the communication terminal 100 is stopped. Details of the temporal condition data will be described later.

The input/output device 103 receives an input operation of the user of the vehicle and presents information to the user. The input/output device 103 includes, for example, a touch panel or a push button capable of inputting symbols such as characters, and an input device such as a microphone capable of inputting voice. Further, the input/output device 103 includes an output device such as a display or a speaker. In one example, the input/output device 103 may be configured to include a touch panel display and a speaker capable of input/output.

The timer 104 outputs a timer operation signal triggered by the arrival of the time set by the control unit 101. The timer activation signal may, in one example, be a signal that includes information indicating the date, day of the week, and time when the timer activation signal was output.

The battery 105 is a secondary battery that serves as a power source for the communication terminal 100. Here, when the vehicle 10 is a vehicle equipped with an internal combustion engine, the battery 105 is charged by using electric power generated during operation of the internal combustion engine. When the vehicle 10 is a BEV (Battery Electric Vehicle) equipped with a driving battery, the vehicle is charged using the electric power of the driving battery.

The communication I/F 106 includes a communication interface for connecting the communication terminal 100 to an in-vehicle network, a radio communication interface for connecting the communication terminal 100 to a network N1 outside the vehicle, and the like. In one instance, the communication I/F 106 may include a communication interface for mobile communication (e.g., 3G, LTE, 5G, 6G, etc.) and a wireless communication interface for near field communication. The communication I/F 106 of the present embodiment communicates with ECU 110 of the vehicle 10 through an in-vehicle network. Further, the communication I/F 106 of the present embodiment communicates with the server 30 through a network N1 outside the vehicle.

ECU 110 of the vehicle 10 is a computer that controls the in-vehicle device 120 mounted on the vehicle 10. The in-vehicle device 120 includes an air conditioner, a door lock actuator, a power window actuator, and the like mounted on the vehicle 10. ECU 110 operates the in-vehicle device 120 in accordance with the remote command received by the communication terminal 100 from the server 30.

Next, the details of the functions realized by the control unit 101 of the communication terminal 100 will be described. Note that the functions described below may be realized by hardware circuitry such as ASIC (Application Specific Integrated Circuit) or FPGA (Field Programmable Gate Array).

The control unit 101 has a function of transmitting a remote command received from the server 30 to ECU 110. Further, the control unit 101 has a function of automatically switching the communication terminal 100 from the standby state to the stop state at a time point when a certain period (for example, about nine days) elapses from the stop of the operation of the vehicle 10 (timing at which the ignition switch or the power switch is switched from the on state to the off state), and a function of accepting a timing condition designated by the user. Further, the control unit 101 has a function of switching between the standby state and the stop state of the communication terminal 100 in accordance with the timing condition designated by the user.

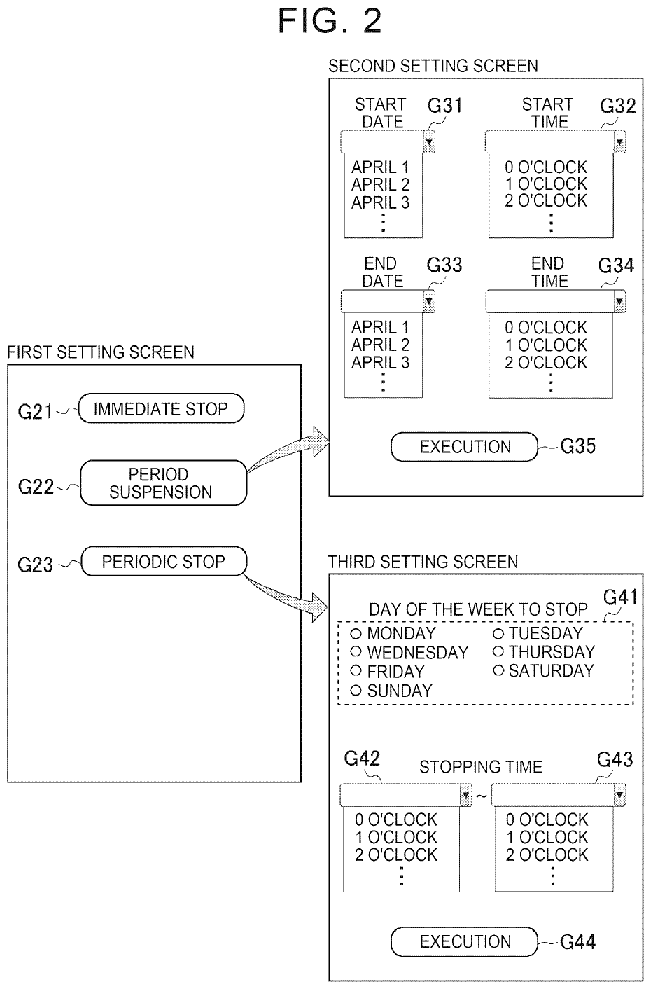

Here, a function of accepting a timing condition designated by a user will be described. The control unit 101 outputs a timing condition setting screen through the input/output device 103. FIG. 2 is a diagram illustrating an example of a setting screen of a timing condition; The first setting screen in FIG. 2 is a screen that is output first in response to the user inputting an operation of calling the setting screen of the timing condition to the input/output device 103. In the exemplary embodiment shown in FIG. 2, an immediate stop button G21, a period stop button G22, and a periodic stop button G23 are included. The immediate stop button G21 is a button that is a GUI component for specifying a condition for immediately stopping the communication terminal 100. The period stop button G22 is a button that is a GUI component for calling a setting screen (second setting screen) for a period in which the communication terminal 100 is temporarily stopped. The periodic stop button G23 is a button that is a GUI component for calling a setting screen (third setting screen) for a period in which the communication terminal 100 is periodically stopped.

When the operation of selecting the period stop button G22 is input to the input/output device 103 while the first setting screen is output to the input/output device 103, the control unit 101 outputs the second setting screen to the input/output device 103. In the embodiment illustrated in FIG. 2, the second setting window includes a pull-down menu G31-G32, a pull-down menu G33-G34, and an execution button G35. The pull-down menu G31-G32 is a pull-down menu for selecting the date and time of the starting time period when the communication terminal 100 is temporarily stopped. The pull-down menu G33-G34 is a pull-down menu that is a GUI component for selecting the date and time of the end of the time period in which the communication terminal 100 is temporarily stopped. The execution button G35 is a button which is a GUI component for executing the single stopping of the communication terminal 100 during the selected period. It should be noted that the date and time options presented in the pull-down menu G31-G32 may be limited to the date and time that the vehicle 10 is in from the last deactivation to the predetermined period. Further, in the example illustrated in FIG. 2, the second setting screen is configured to select both the date and the time for the start time and the end time of the period in which the communication terminal 100 is temporarily stopped. However, the second setting window may be configured to select only the date (omit GUI component G32 and GUI component G34 in FIG. 2).

When an operation of selecting a periodic stop button G23 is input to the input/output device 103 while the first setting screen is output to the input/output device 103, the control unit 101 outputs the third setting screen to the input/output device 103. In the embodiment illustrated in FIG. 2, the third setting window includes a checkbox G41, a pull-down menu G42-G43, and an execution button G44. The checkbox G41 is a check box which is a GUI component for selecting a day of the week on which the communication terminal 100 is periodically stopped. The pull-down menu G42-G43 is a pull-down menu that is a GUI component for selecting a period in which the communication terminal 100 is periodically stopped. The execution button G44 is a button that is a GUI component for executing the periodic stopping of the communication terminal 100 on the selected day of the week and/or in the timezone. In the third setting screen, it is not necessary to select both the day of the week and the time period in which the communication terminal 100 is periodically stopped, and at least one of the day of the week and the time period may be selected.

Next, a function of switching between the standby state and the stop state of the communication terminal 100 in accordance with the timing condition designated by the user will be described. First, in the first setting window described with reference to FIG. 2, when the immediate stop button G21 is operated, the control unit 101 immediately switches the communication terminal 100 from the standby state to the stopped state.

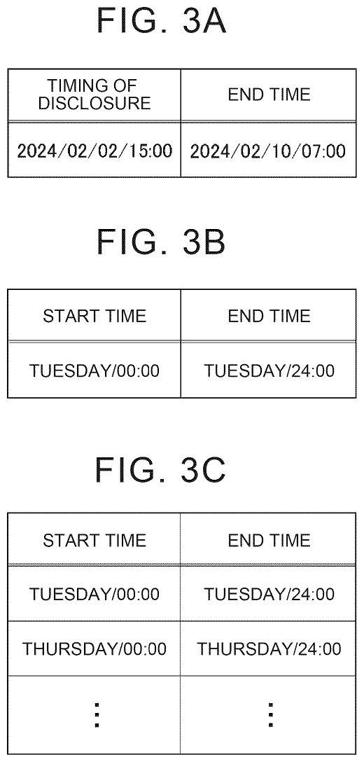

Further, in the second setting window described with reference to FIG. 2, the execution button G35 may be operated after the starting time and the ending time of a time period in which the communication terminal 100 is temporarily stopped are selected. In this case, the control unit 101 first registers the temporal condition data in the storage unit 102. Here, a specific example of the timing-specific condition-data stored in the storage unit 102 will be described with reference to FIGS. 3A to 3C. FIG. 3A is an exemplary temporal conditional datum when the communication terminal 100 is temporarily stopped. The periodic conditional data in FIG. 3A includes a start time field and an end time field for a time period in which the communication terminal 100 is temporarily stopped. In the start time field, information indicating the date and time of the start time selected on the second setting screen is registered. In the end time field, information indicating the date and time of the end time selected on the second setting screen is registered.

The control unit 101 sets the timer 104 after the timing condition data as shown in FIG. 3A is registered in the storage unit 102. Specifically, each of the start time and the end time registered in the start time field and the end time field of the temporal condition data as shown in the FIG. 3A arrives. At this time, the control unit 101 sets the operation timing of the timer 104 so that the timer operation signal is output. Thereafter, in response to the timer 104 outputting the timer operation signal, the control unit 101 compares the date and time when the timer operation signal is output with the temporal condition data of the storage unit 102. At this time, if the date and time at which the timer operation signal is output coincide with the date and time registered in the start time field of the temporal condition data, the control unit 101 switches the communication terminal 100 from the standby state to the stop state. When the date and time at which the timer operation signal is output coincides with the date and time registered in the end time field of the temporal condition data, the control unit 101 switches the communication terminal 100 from the stopped state to the standby state.

In addition, in the third setting window described with reference to FIG. 2, when the execution button G44 is operated after the day of the week and/or the time zone in which the communication terminal 100 is periodically stopped is selected, the control unit 101 first registers the temporal conditional data in the storage unit 102. As illustrated in FIG. 3B, the start time of the time period selected on the third setting screen and the start time of the time period selected on the third setting screen are registered in the start time period field of the time period condition. In the end time field, information indicating the day of the week selected on the third setting screen and the end time of the time zone selected on the third setting screen is registered. When a plurality of days of the week are selected in the third setting window, the time period condition may include a record corresponding to each of the plurality of days of the week, as illustrated in FIG. 3C.

The control unit 101 sets the operation timing of the timer 104 such that the timer operation signal is repeatedly outputted every time each of the start timing and the end timing arrives after the timing conditional data as shown in FIG. 3B is registered in the storage unit 102. Here, the start time and the end time are registered in the start time field and the end time field of the temporal condition data as shown in FIG. 3B. Thereafter, in response to the timer 104 outputting the timer operation signal, the control unit 101 compares the day of the week and the time at which the timer operation signal is output with the temporal condition data of the storage unit 102. At this time, if the day of the week and the time when the timer operation signal is output coincides with the day of the week and the time registered in the start time field of the temporal condition data, the control unit 101 switches the communication terminal 100 from the standby state to the stop state. When the day of the week and the time at which the timer operation signal is output coincides with the day of the week and the time registered in the end time field of the temporal condition data, the control unit 101 switches the communication terminal 100 from the stopped state to the standby state. The process of switching between the standby state and the stop state of the communication terminal 100 in this manner is repeatedly executed every time the day of the week and the time zone selected on the third setting screen arrive.

### Processing Flow

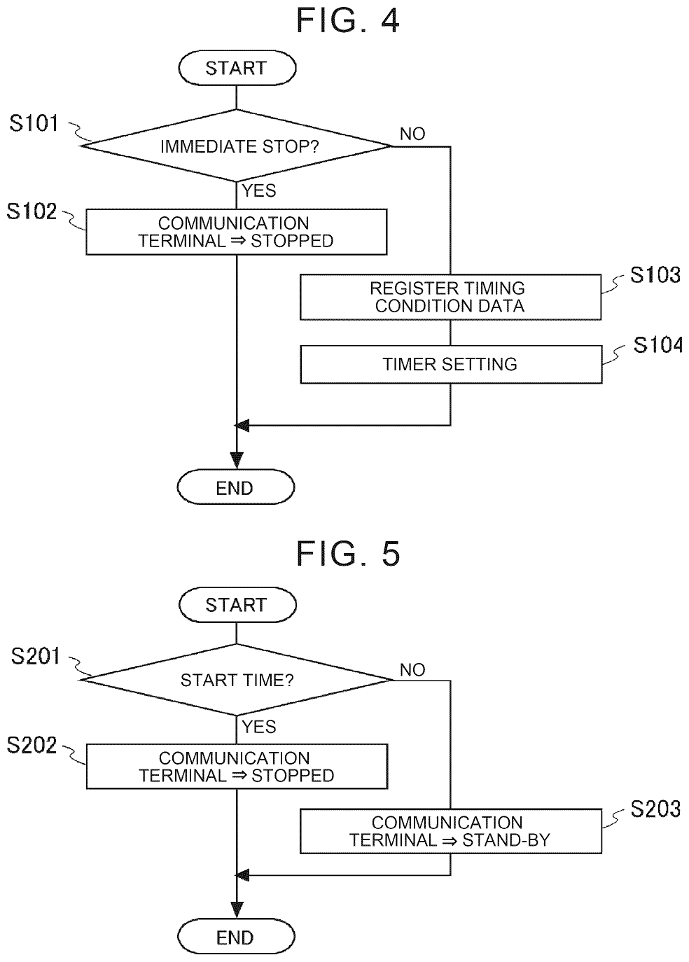

Next, a flow of processing executed by the communication terminal 100 according to the present embodiment will be described with reference to FIG. 4 and FIG. 5. FIG. 4 is a flowchart illustrating a first processing routine executed by the communication terminal 100 in response to an operation of specifying a timing condition by a user of the vehicle 10 being input to the input/output device 103. FIG. 5 is a flowchart illustrating a second processing routine executed by the communication terminal 100 in response to the timer 104 outputting a timer operation signal.

When an operation for specifying a timing condition is input to the input/output device 103 by the user of the vehicle 10, the control unit 101 of the communication terminal 100 executes the first processing routine of FIG. 4. The “operation for specifying a timing condition” referred to here is any one of the previous first operation, the second operation, and the third operation. Here, the first operation is an operation of selecting an immediate stop button G21 in the first setting window illustrated in FIG. 2. The second operation is an operation of selecting an execution button G35 after selecting a starting time and an ending time in the second setting window illustrated in FIG. 2. The third operation is an operation of selecting the execution button G44 after selecting the day of the week and the time zone in the third setting window illustrated in FIG. 2.

In the first process of FIG. 4, the control unit 101 first determines whether the temporal condition designated by the user of the vehicle 10 is a condition for immediately stopping the communication terminal 100 (S101). Here, the operation of specifying the timing condition may be an operation of selecting an immediate stop button G21 in the first setting window illustrated in FIG. 2. In this case, the control unit 101 determines that the timing condition designated by the user of the vehicle 10 is a condition for immediately stopping the communication terminal 100 (affirmative determination in S101). Further, the operation of specifying the timing condition may be an operation of selecting the execution button G35 after selecting the start time and the end time in the second setting screen illustrated in FIG. 2, or an operation of selecting the execution button G44 after selecting the day of the week and the time zone in the third setting screen illustrated in FIG. 2. In these cases, the control unit 101 determines that the timing condition designated by the user of the vehicle 10 is not a condition for immediately stopping the communication terminal 100 (negative determination in S101).

When an affirmative determination is made on S101, the control unit 101 executes S102 process. In S102, the control unit 101 immediately switches the communication terminal 100 from the standby state to the stopped state.

When a negative determination is made in S101, the control unit 101 executes S103 process. In S103, the control unit 101 generates the temporal condition data based on the temporal condition specified by the user of the vehicle 10, and registers the generated temporal condition data in the storage unit 102. Here, the timing condition designated by the user of the vehicle 10 may be a condition for designating a period in which the communication terminal 100 is temporarily stopped. In this case, the control unit 101 may generate and register the temporal condition data as exemplified in the above-described FIG. 3A in the storage unit 102. In addition, the periodic condition designated by the user of the vehicle 10 may be a condition for designating a day of the week and/or a time zone in which the communication terminal 100 is periodically stopped. In this case, the control unit 101 may generate and register the temporal condition data as exemplified in the above-described FIGS. 3B and 3C in the storage unit 102. Upon completion of S103 process, the control unit 101 executes S104 process.

In S104, the control unit 101 sets the timer 104 in accordance with the temporal condition data registered in the storage unit 102. Here, the timing condition designated by the user of the vehicle 10 may be a condition for designating a period in which the communication terminal 100 is temporarily stopped. In this case, the control unit 101 sets the operation timing of the timer 104 such that the timer operation signal is outputted at each of the start timing and the end timing registered in the start timing field and the end timing field of the timing-specific condition data as illustrated in FIG. 3A. In addition, the timing condition designated by the user of the vehicle 10 may be a condition for designating a day of the week and/or a time zone in which the communication terminal 100 is periodically stopped. In this case, the control unit 101 sets the operation timing of the timer 104 such that the timer operation signal is outputted every time each of the start timing and the end timing registered in the start timing field and the end timing field of the temporal condition data as exemplified in FIG. 3B or FIG. 3C of the drawing arrives. When S104 processing is finished, the control unit 101 ends the execution of the first processing routine.

In some cases, the operation timing of the timer 104 is set in the first processing routine, such as a case where the timing condition designated by the user of the vehicle 10 is a condition for designating a period in which the communication terminal 100 is temporarily stopped, and a case where the timing condition is a condition for designating a day of the week and/or a time zone in which the communication terminal 100 is periodically stopped. In these cases, the timer 104 outputs a timer activation signal triggered by the arrival of the activation time. When the timer 104 outputs the timer operation signal, the control unit 101 of the communication terminal 100 executes the second processing routine illustrated in FIG. 5.

In the second processing routine, the control unit 101 first compares information included in the timer operation signal (for example, information indicating the date, day of the week, and time when the timer operation signal is output) with the temporal condition data registered in the storage unit 102. Accordingly, the control unit 101 determines whether or not the start time registered in the start time field of the temporal condition data has arrived (S201). At this time, the information included in the timer operation signal may coincide with the start time registered in the start time field of the temporal condition data. In this case, the control unit 101 determines that the start time of the period in which the communication terminal 100 is temporarily placed in the stopped state has arrived, or determines that the start time of the day of the week and/or the time zone in which the communication terminal 100 is periodically placed in the stopped state has arrived (affirmative determination in S201). On the other hand, the information included in the timer operation signal may not coincide with the start time registered in the start time field of the timing condition data, and the information included in the timer operation signal may coincide with the end time registered in the end time field of the timing condition data. In this case, the control unit 101 determines that the end time of the period in which the communication terminal 100 is temporarily placed in the stopped state has arrived, or determines that the end time of the day of the week and/or the time zone in which the communication terminal 100 is periodically placed in the stopped state has arrived (negative determination in S201).

When an affirmative determination is made in S201, the control unit 101 executes S202 process. In S202, the control unit 101 switches the communication terminal 100 from the standby state to the stopped state. When S202 process is completed, the control unit 101 terminates the second process routine.

When a negative determination is made in S201, the control unit 101 executes S203 process. In S203, the control unit 101 switches the communication terminal 100 from the stopped state to the standby state. When S203 process is completed, the control unit 101 terminates the second process routine.

According to the above-described embodiment, the communication terminal 100 can be placed in a stopped state at a time specified by the user. Accordingly, by specifying a time when the user does not use the vehicle 10, it is possible to suppress the communication terminal 100 from keeping waiting in the standby state at the time. As a result, unnecessary consumption of the battery 105 can be suppressed. Therefore, the communication terminal 100 can be made to stand-by in the standby state as much as possible at a time other than the time specified by the user, and the convenience of the user can be improved.

### Modified Examples

Next, a modification of the present disclosure will be described. In the present modification example, an example will be described in which the communication terminal 100 determines a candidate of a temporal condition according to a result of a time when the user has used the vehicle 10 in the past, and proposes the determined candidate to the user. Note that, in the present modification example, a configuration different from the above-described embodiment will be described, and description of the same configuration will be omitted.

In the communication terminal 100 according to the present modification, the control unit 101 collects the actual data of the time when the user uses the vehicle 10 (the day of the week and/or the time zone when the user drives the vehicle 10) in the past predetermined time period (for example, a time period of about one month to two months). The control unit 101 stores the collected result data in the storage unit 102. The control unit 101 determines candidates for temporal conditions according to the actual results data stored in the storage unit 102. In an example, the control unit 101 specifies a day of the week and/or a time zone in which the user does not use the vehicle 10 in accordance with the actual data, and determines the specified day of the week and/or time zone as a candidate of the temporal condition. When the candidates for the timing condition are determined in this manner, the control unit 101 outputs a screen (hereinafter, sometimes referred to as a “proposal screen”) for allowing the user to select whether to agree with the determined candidates to the input/output device 103. The suggestion window may include, for example, text information indicating the content of the candidate (text information indicating a day of the week and/or a time zone when the communication terminal 100 is stopped), and a GUI component for selecting whether or not to agree to put the communication terminal 100 in a stopped state according to the candidate. Then, when an operation of selecting that the communication terminal 100 is agreed to be stopped in accordance with the candidate is input to the input/output device 103, the control unit 101 sets the candidate as a timing condition. That is, the control unit 101 generates the temporal condition data corresponding to the candidate, and registers the generated temporal condition data in the storage unit 102. Further, the control unit 101 sets the operation timing of the timer 104 so that the timer operation signal is repeatedly output every time each of the start timing and the end timing registered in the start timing field and the end timing field of the temporal condition data registered in the storage unit 102 arrives. Thereafter, in response to the timer 104 outputting the timer operation signal, the control unit 101 switches between the standby state and the stop state of the communication terminal 100.

### Processing Flow

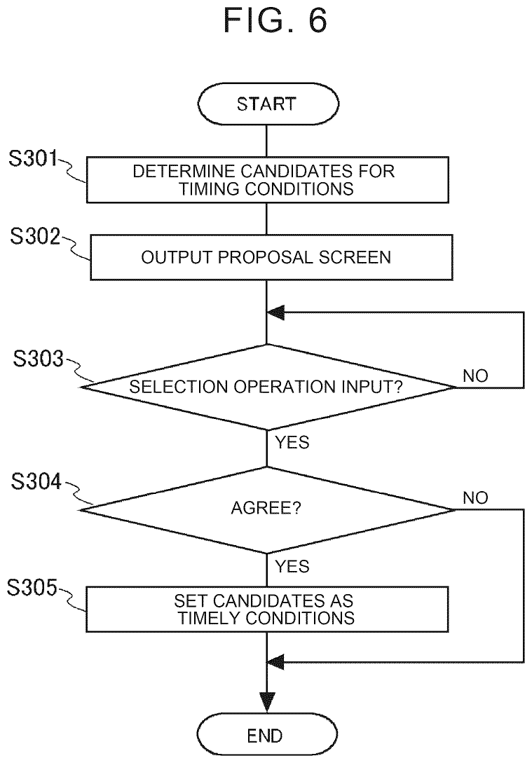

Next, a flow of processing executed by the communication terminal 100 according to the present modification will be described with reference to FIG. 6. FIG. 6 is a flowchart illustrating a third processing routine executed in the communication terminal 100 at a predetermined cycle (for example, every month).

In the third process of FIG. 6, the control unit 101 of the communication terminal 100 first determines candidates for the temporal condition in accordance with the actual results stored in the storage unit 102 (S301). In an example, the control unit 101 specifies a day of the week and/or a time zone in which the user does not use the vehicle 10 in accordance with the actual data, and determines the specified day of the week and/or time zone as a candidate of the temporal condition. Upon completion of S301 process, the control unit 101 executes S302 process.

In S302, the control unit 101 outputs a proposal window for proposing the candidates determined by S301 to the user through the input/output device 103. The suggestion window may include, in one example, text information indicating the content of the candidate (text information indicating the day of the week and/or the time zone when the communication terminal 100 is stopped), and a GUI component for selecting whether or not to agree to put the communication terminal 100 in the stopped state according to the candidate. Upon completion of S302 process, the control unit 101 executes S303 process.

In S303, the control unit 101 determines whether or not the input/output device 103 has received an operation of selecting whether or not to agree with the candidates while the proposal window is being outputted to the input/output device 103. When the operation of selecting whether to agree with the candidate is not input to the input/output device 103 (negative determination in S303), the control unit 101 waits until the operation of selecting whether to agree with the candidate is input to the input/output device 103. In addition, when the input/output device 103 receives an operation of selecting whether to agree with the candidates (affirmative determination in S303), the control unit 101 executes S304 process.

In S304, the control unit 101 determines whether the operation inputted to the input/output device 103 is an operation of selecting to agree with the candidates. When the operation inputted to the input/output device 103 is an operation of selecting that the candidates are not agreed to (negative determination in S304), the control unit 101 ends the third process routine. On the other hand, when the operation input to the input/output device 103 is an operation of selecting to agree with the candidates (affirmative determination in S304), the control unit 101 executes S305 process.

In S305, the control unit 101 sets the candidates as temporal conditions. Specifically, the control unit 101 generates temporal condition data corresponding to the candidate, and registers the generated temporal condition data in the storage unit 102. Further, the control unit 101 sets the operation timing of the timer 104 so that the timer operation signal is repeatedly output every time each of the start timing and the end timing arrives. Here, the start time and the end time are registered in the start time field and the end time field of the temporal condition data registered in the storage unit 102. When S305 processing is finished, the control unit 101 ends the execution of the third processing routine.

According to the modification described above, it is possible to reduce the time and effort when the user sets the timing condition. As a result, the convenience of the user can be further enhanced.

### Other

The above-described embodiment and modifications are merely examples, and the present disclosure may be appropriately modified to be implemented without departing from the scope thereof. In addition, the processes and means described in the present disclosure can be freely combined and implemented as long as there is no technical inconsistency. Moreover, the processes described as being executed by one device may be shared and executed by a plurality of devices. For example, among the functions realized by the communication terminal 100 of the vehicle 10, a function of accepting a timing condition designated by the user of the vehicle 10 may be realized by the user terminal 20. In this case, the user terminal 20 may be configured to realize a function of presenting a setting screen as illustrated in FIG. 2 to the user and a function of transmitting a timing condition designated by the user on the setting screen to the server 30. Accordingly, the server 30 may be configured to realize a function of transmitting the timing condition received from the user terminal 20 to the communication terminal 100 of the vehicle 10. The communication terminal 100 of the vehicle 10 may switch between the standby state and the stop state according to the timing condition received from the server 30.

In addition, among the functions realized by the communication terminal 100 of the vehicle 10, a function of determining a candidate of a timing condition may be realized by the server 30. In this case, the server 30 may be configured to realize three functions. Here, the three functions are a function of collecting the performance data through the communication terminal 100 of the vehicle 10, a function of determining a candidate of a timing condition based on the collected performance data, and a function of transmitting the determined candidate information to the communication terminal 100. In addition, among the functions realized by the communication terminal 100 of the vehicle 10, the function of presenting the proposal screen to the user may be realized by the user terminal 20. In this case, the user terminal 20 may be configured to realize three functions. Here, the three functions are a function of acquiring the candidate information determined by the communication terminal 100 through the server 30 (or a function of acquiring the candidate information determined by the server 30 from the server 30), a function of presenting a proposal screen to the user based on the acquired candidate information, and a function of transmitting a result selected by the user on the proposal screen (a selection result of whether or not to agree with the candidate) to the server 30. Accordingly, the server 30 may be configured to realize a function of transmitting the selection result received from the user terminal 20 to the communication terminal 100 of the vehicle 10. Then, the communication terminal 100 of the vehicle 10 may determine whether to set the candidate as the timing condition in accordance with the selection result received from the server 30.

Further, the present disclosure can also be realized by supplying a computer program to the communication terminal 100 of the vehicle 10, and one or more processors included in the communication terminal 100 read and execute the computer program. Here, the computer program implements the functions described in the above embodiments. Such a computer program may be provided to the computer by a non-transitory computer-readable storage medium connectable to the system bus of the computer, or may be provided to the computer via a network. The non-transitory computer readable storage medium is a recording medium which can store information, such as data and programs, by an electric, magnetic, optical, mechanical, or chemical action and which can read the information from a computer or the like. Such a recording medium may be, for example, any type of disk, such as a magnetic disk (floppy (registered trademark) disk, hard disk drive (HDD), or the like) or an optical disk (CD-ROM, DVD disk, Blu-ray disk, or the like). The recording medium may be a medium such as read-only memory (ROM), random access memory (RAM), EPROM, EEPROM, magnetic card, flash memory, optical card, or SSD (Solid State Drive).

What is claimed is:

1. An information processing device, comprising: a control unit that executes
acquiring of a condition that is specified by a user of a vehicle, and that is a time-related condition that is a condition for specifying a period for a communication function of the vehicle relating to remote operations to be placed in at least one of a stopped state and a standby state, and
placing the communication function in at least one of the stopped state or the standby state in accordance with the time-related condition that is acquired.

2. The information processing device according to claim 1, wherein:
the time-related condition is a condition for immediately placing the communication function in the stopped state; and
in accordance with reception of the time-related condition, the control unit immediately places the communication function in the stopped state.

3. The information processing device according to claim 1, wherein:
the time-related condition is a condition for specifying a period for temporarily placing the communication function in the stopped state; and
the control unit executes placing the communication function in the stopped state in accordance with a start time of the period arriving, and placing the communication function in the standby state in accordance with an end time of the period arriving.

4. The information processing device according to claim 1, wherein:
the time-related condition is a condition for specifying at least one of a day of a week and a part of day for regularly placing the communication function in the stopped state; and
the control unit executes placing the communication function in the stopped state every time at least one of the day of the week and the part of day arrives, and placing the communication function in the standby state every time at least one of the day of the week and the part of day ends.

5. The information processing device according to claim 1, wherein the control unit further executes
determining a candidate of the time-related condition according to history of a time when the user used the vehicle in a past;
outputting information for causing the user to select whether to consent to the candidate; and
setting the candidate to the time-related condition in accordance with consent of the user to the candidate.
